(19) United States
(12) Patent Application Publication
(10) Pub. No.: US 2004/0225516 A1
(43) Pub. Date: Nov. 11, 2004

(54) Automated filling station with change dispenser

(76) Inventors: Thomas P. Bruskotter, Englewood, CO (US); Edward M. Swapp, Englewood, CO (US); Michael Kurowski, Littleton, CO (US)

Correspondence Address: MARSH FISCHMANN & BREYFOGLE LLP, Suite 411, 3151 South Vaughn Way, Aurora, CO, 80014, US

(21) Appl. No.: 10/702,107

(22) Filed: Nov. 5, 2003

Related U.S. Application Data
(63) Continuation of application No. 09/295,265, filed on Apr. 20, 1999, now abandoned.
Application No. 09/295,265 is a continuation-in-part of application No. PCT/US98/11160, filed on Jun. 3, 1998.
Application No. 09/295,265 is a continuation-in-part of application No. 08/946,304, filed on Oct. 7, 1997, now Pat. No. 5,895,457.
Application No. 08/946,304 is a continuation-in-part of application No. 08/868,247, filed on Jun. 3, 1997, now abandoned.

(51) Int. Cl. G06F 17/60

(52) U.S. Cl. 705/1

(57) ABSTRACT

The automated filling station system of the present invention allows customers to obtain change in currency at the time of purchase, thereby accommodating cash customers as well as credit customers, and one-time customers as well as returning customers. In one embodiment, the system is implemented as a network (10) of filling stations (16) that report to a remote host computer (12). The remote host computer (12) allows multiple filling stations to be interconnected. In addition, the remote host computer (12) allows malfunctions to be remotely diagnosed and corrected. Each filling station (16) has a number of fuel pump systems (22) and a change dispenser system (24). Upon completion of a fueling transaction, a code is provided to a customer at a fuel pump system (22). The customer can enter the code to receive cash at the change dispenser (24) or can use the code for credit towards a subsequent fuel purchase within the network (10).

### CROSS-REFERENCE TO RELATED APPLICATIONS

This patent application is a continuation of U.S. patent application Ser. No. 09/295,265, filed on Apr. 20, 1999, which is a continuation-in-part of PCT Patent Application Serial No. PCT/US98/11160 filed on Jun. 3, 1998, which claims priority from U.S. patent application Ser. No. 08/946,304 filed on Oct. 7, 1997 which issued as U.S. Pat. No. 5,895,457 on Apr. 20, 1999, which is a continuation-in-part of U.S. patent application Ser. No. 08/868,247, filed on Jun. 3, 1997, all of which are hereby incorporated by reference in their entirety.

### FIELD OF THE INVENTION

The present invention relates in general to the operation of filling stations, i.e., retail outlets for the sale of gasoline, diesel or other fuel. In particular, the present invention relates to a method and apparatus for automating a filling station to facilitate remote operation and payment in forms including cash payment.

### BACKGROUND OF THE INVENTION

Increasing automation of filling stations offers a number of potential advantages including customer convenience, reduced labor and risk to personnel, and lower prices. Customer convenience may be enhanced due to longer hours of operation, more service sites and reduced transaction times. In addition to the advantages of reduced personnel and working hours, automation of filling stations improves personnel safety by reducing cash handling. Reduced operating costs also benefit consumers through lower prices. For all of these reasons, the industry has long sought ways to increase filling station automation.

One form of automation that has gained widespread acceptance is the ability to pay at the pump using credit or debit cards. Typically, a card reader and a monitor are provided at the pump. The monitor prompts the customer to initiate a transaction by inserting a card into the card reader. Upon reading the card, the pump system accesses a card approval service, e.g., the BUYPASS, PAYPOINT or other credit card authorization network, in order to obtain card approval for a selected approval amount. The approval amount does not necessarily accurately reflect the subsequent fueling transaction amount. If approval is obtained, the pump system is enabled and the customer may proceed with fueling. Alternatively, where available, so-called smart card systems may allow for payment approval without accessing an external approval service.

Another type of system that is in limited use allows for cash payments. A difficulty associated with cash payments is that customers often desire to fill their tanks and therefore do not know the transaction amount ahead of time. Other customers may wish to receive change to have available for other reasons. One existing system addresses this problem by providing credit vouchers in the event that a balance remains upon completion of the fueling process. In this manner, the customer can pay in cash in an amount sufficient to cover a fill-up. When the fueling process is complete, the credit voucher system issues a voucher that is coded, e.g., with a six digit code, to indicate a balance owed to the customer as change. On a subsequent visit, the customer can enter the code into a keypad of the pump system to receive credit corresponding to the amount of the previously unused payment or balance.

Although existing systems have benefited the industry and some consumers and have achieved significant success with respect to certain segments of the market, the present invention addresses various needs that remain to be satisfied.

### SUMMARY OF THE INVENTION

It has been recognized that existing automated filling station systems do not address the needs of a range of consumers. In this regard, credit card based pay-at-the-pump systems do not accommodate customers who do not have or do not wish to use credit cards. In addition, the increased transaction costs associated with credit cards are reflected in higher prices for credit card customers or all customers. Credit voucher systems may be convenient for returning customers but are unattractive to customers who are only transiently present in a service area (e.g., interstate traffic), and to customers who would prefer not to be responsible for keeping track of vouchers or who would otherwise prefer not to be limited to returning to the same vendor.

The present invention is directed to an automated filling station system that accommodates the needs of customers including cash customers by providing change in the form of currency. The system encompasses a process and corresponding structure involving, inter alia: providing a pump system for dispensing fuel including a payment processor for receiving payments from customers and controlling operation of the pump system in response to such payments; receiving a payment from a customer in a customer selected amount at the pump system; monitoring a fueling process by the customer to identify a completion of the process (e.g., returning the fuel nozzle to its hanger or turning the pump off) and determining an amount due associated with the fueling process; comparing the customer selected payment amount to the amount due to determine any balance due to the customer in connection with the fueling process; providing a change dispenser for dispensing change in the form of currency (e.g., bills and/or coins); and controlling operation of the change dispenser to provide change in currency to a customer based on the determined balance due to the customer. The pump system is preferably capable of receiving payment in various forms including credit and debit cards or the like, cash and previously issued tickets or credit vouchers (for the convenience of returning customers): The pump system may therefore include a magnetic or other card reader, bill and coin slots, and/or a credit voucher slot and will typically include at least a card reader and bill slot. The change dispenser, which may be provided at the pump or a separate location, preferably provides change in multiple denominations, e.g., some or all of United States ten dollar bills, five dollar bills, one dollar bills, quarters, dimes, nickels and pennies. A system is thus provided that accommodates cash customers as well as credit customers, and one-time customers as well as returning customers.

According to one aspect of the present invention, operation of the change dispenser is controlled based on code information. In particular, the automated filling station system includes logic (e.g., hardware, firmware and/or software) for generating transaction specific codes (e.g., numeric or alphanumeric) and associating particular codes with particular transactions to indicate a balance due in connection with the transaction. For example, upon receiving a “fueling complete” signal from a pump, the logic may obtain/retrieve the customer-selected payment amount and the transaction amount, compare these amounts to determine a balance due, generate a random or selected string of characters or password to serve as a code, create a file or the like in memory (e.g., computer memory, buffer storage and/or cache storage) relating the code to the determined balance due, and transmitting the coded balance information to, or otherwise making the coded balance information available to, the change dispenser. The logic is preferably embodied in software so as to allow on-site or remote access without hardware replacement or modification.

The balance code can be, for example, embedded in a machine readable ticket, displayed to the customer on a monitor, or printed on a receipt. The change dispenser includes a code processor and a customer input device such as a ticket slot, keyboard or the like. The code processor receives a code from the customer via the customer input device, and the dispenser dispenses change to the customer based on the code and coded balance information stored in a database. This coded control of the change dispenser allows customers to choose between cashing in any balance due or saving the balance for application towards a subsequent fueling transaction, and also provides improved filling station configuration and servicing options.

According to another aspect of the present invention, a centralized change dispenser is associated or networked with multiple (two or more) pump systems via a control system. The control system generates coded balance information for particular transactions as described above and makes the coded balance information available to the change dispenser. The pump systems provide corresponding codes to customers who are due a balance. If change is desired, as opposed to credit towards a future transaction, the customer approaches the centralized change dispenser from any of the pump systems and enters the transaction-specific code. The change dispenser is able to dispense change to customers from each of the pump systems based on the coded balance information by virtue of the networked relationship.

In a related aspect of the present invention, the filling station and its controller may be networked, in turn, with other filling stations and a remotely located computer center (e.g., a remote host computer controllable by administrative personnel). In this manner, operation of a networked system of automated filling stations may be greatly simplified. As may be appreciated, the networking of the filling stations facilitates tracking and management of servicing of the pump systems (e.g.; refueling scheduling) and of the change machines (e.g., addressing malfunctions and removing and resupplying currency). In this regard, the remote computer center may be networked to communicate with a service administrator that maintains the pump systems and/or change dispensers. Further, the controllers may be configured to store data including fuel pumped amounts and currency received and currency dispensed amounts. This data may be periodically (e.g., daily, weekly, monthly or as desired) communicated or downloaded to the remote computer center to be used to plan maintenance and calculate profitability of each filling station. As may be appreciated, networking may be accomplished through various methods, such as the use of telecommunication systems and/or the Internet.

A further benefit of networking the filling stations is that reprogramming to change certain system parameters related to code validation and termination and the like is simplified. For example, fuel codes may be quickly and remotely verified and/or periodically changed at the remote computer center without having personnel traveling to each filling station. Similarly, fuel prices may be remotely changed by the remote computer center and transmitted to the controllers at each filling station for display (e.g., at the pump system for customer viewing) and for calculating transaction amounts. As can be appreciated, remote control of fuel prices is important as prices may fluctuate station to station based on location and periodically at the same station. Further regarding fuel prices, the controller at each filling station may be interconnected with any display systems (e.g., automated billboards) associated with the filling station to allow these displays to be remotely changed to reflect current fuel prices.

In a further related aspect of the present invention, each filling station may include an alarm system for monitoring the physical integrity of the change dispenser and/or the pump systems. The alarm system may be designed to monitor these components for problems due to theft, vandalism, and other occurrences that breach physical integrity. As can be appreciated, it may be desirable that the alarm system communicate current status and emergency information to the networked remote computer center via the controller of each filling station. In this regard, the present invention recognizes the importance of interconnecting (e.g., through the Internet or telecommunication systems) the remote computer center with an emergency response center which would address serious problems such as theft. As may be appreciated, the emergency response center may include, for example, a security service, employer managed response personnel, and public law enforcement. In this manner, a single remote computer center may monitor many networked filling stations against theft or other damage that may detrimentally effect operation of an automated filling station.

In still another related aspect of the present invention, each filling station may include a dedicated communication system for use by customers. In this manner, customers may direct operational problems to the remote computer center for prompt resolution. One problem associated with automated filling stations is that when equipment malfunctions (e.g., currency or credit vouchers may jam in the pump systems or change dispensers) there are no service personnel on site to resolve the problem. With a dedicated communication system, a customer who experiences problems, such as a currency jam at the pump system bill accepter or change dispenser that results in incorrect change being dispensed, incorrect credit being applied or no fuel being dispensed, may communicate this problem to the remote computer center. The remote computer center may address the problem promptly by identifying the problem based on a bill jam alarm, unit malfunction alarm, or direct contact from a customer and then issuing a change back code corresponding to a refund amount. As may be appreciated, the change back code may take various forms, including a credit voucher, a fuel authorization code, and a coded receipt. Such a code may be orally communicated to the customer or displayed or printed, e.g., at the pump system or change dispenser. In this regard, the communication system may include, for example, a keyboard at the change dispenser that communicates with the remote computer center via the Internet, a telephone system operable through a direct line to the computer center, or a public telephone with a free access number provided. Upon receiving a customer's communication or alarm, the remote computer center may verify the existence of the problem (e.g., that the customer has a proper, unredeemed balance code or that a bill accepter has identified but not credited a particular currency value) and then either transmit a new balance or refund code for use in the change dispenser or at the pump system.

The automated filling station system of the present invention thus accommodates cash customers as well as credit customers and one-time customers as well as returning customers, and thereby more fully realizes the potential benefits of automated filling stations. The invention also simplifies filling station servicing and remote access and control of automated filling stations.

### BRIEF DESCRIPTION OF THE DRAWINGS

For a more complete understanding of the present invention and further advantages thereof, reference is now made to the following detailed description taken in conjunction with the drawings in which:

FIG. 1 is a schematic diagram of an automated filling station network in accordance with the present invention;

FIG. 2 is a schematic diagram showing the components at an individual filling station site of the network of FIG. 1;

FIG. 3 is a flow chart illustrating a pump system related process according to the present invention;

FIG. 4 is a flow chart illustrating a change dispenser system related process according to the present invention;

FIG. 5 is a chart outlining various functions and implementation options of the network of FIG. 1; and

FIG. 6 is a schematic diagram of an automated filling station network in accordance with the present invention.

### DETAILED DESCRIPTION OF THE INVENTION

In the following description, the invention is set forth in the context of a particular automated filling station environment. It will be appreciated that certain aspects of the present invention are applicable to other environments. The automated filling station implementation of the present invention can be a single site system or a network of filling stations, can be a stand-alone filling station or associated with a convenience store, supermarket, department store, discount store, etc., and can be manned or unmanned. Numerous other environmental factors can be varied as desired. For the sake of completeness, the illustrative embodiment of the invention described below is set forth in the context of a network of filling stations, some of which are associated with stores.

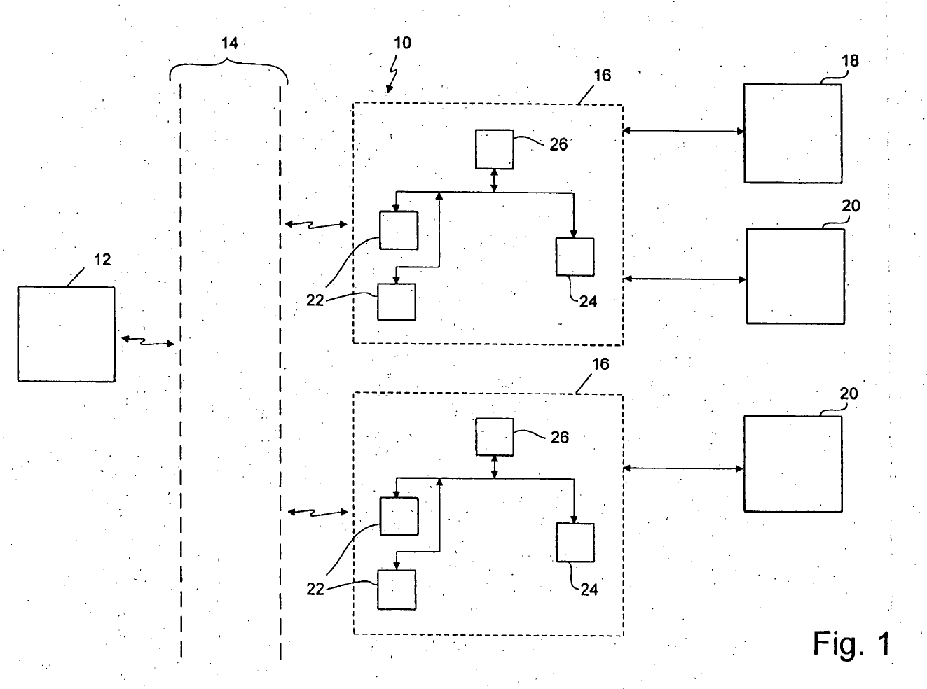

Referring to FIG. 1, an automated filling station network is generally identified by the reference numeral 10. Generally, the network 10 includes a number of filling station sites 16 that communicate with a remote host computer 12, via a public or private communications network 14, such as the Internet. Although the illustrated network 10 is shown as including only two filling station sites 16, it will be appreciated that any number of filling stations may be included in the network 10.

Each filling station site 16 includes a number of fuel pump systems 22, at least one change dispenser system 24, and a site controller 26. Again, although the illustrated filling station sites 16 are shown as including only two fuel pump systems 22, each site 16 can include any number of fuel pump systems 22. Similarly, although a single change dispenser 24 per site 16 is preferred for ease of maintenance, any number of change dispensers 24 per site 16 can be included as desired. For example, certain aspects of the present invention may be implemented in connection with embodiments where the change dispenser can be incorporated into the individual pump systems rather than provided separately as shown. The site controller 26 implements logic as will be described below. The logic can be embodied in hardware, firmware or software. Preferably, the logic is embodied in software so as to facilitate remote or onsite revisions and updates without changing or modifying hardware. A number of interfaces are also shown at each filling station site 16. Such interfaces can include a store data system interface 18, and maintenance and restocking interfaces 20. The store data system interface 18 is particularly applicable where the filling station site 16 is associated with a convenience, discount or other store. The interface 18, which may be any suitable network connection, allows the store data system and the network data system to exchange data for inventory, accounting and other purposes. The maintenance and restocking interfaces 20, which may include a user interface device such as a keyboard and a scanner for reading identification cards, are provided for tracking refueling of the filling station site 16, restocking of the change dispenser 24, onsite administrative updates, and other purposes.

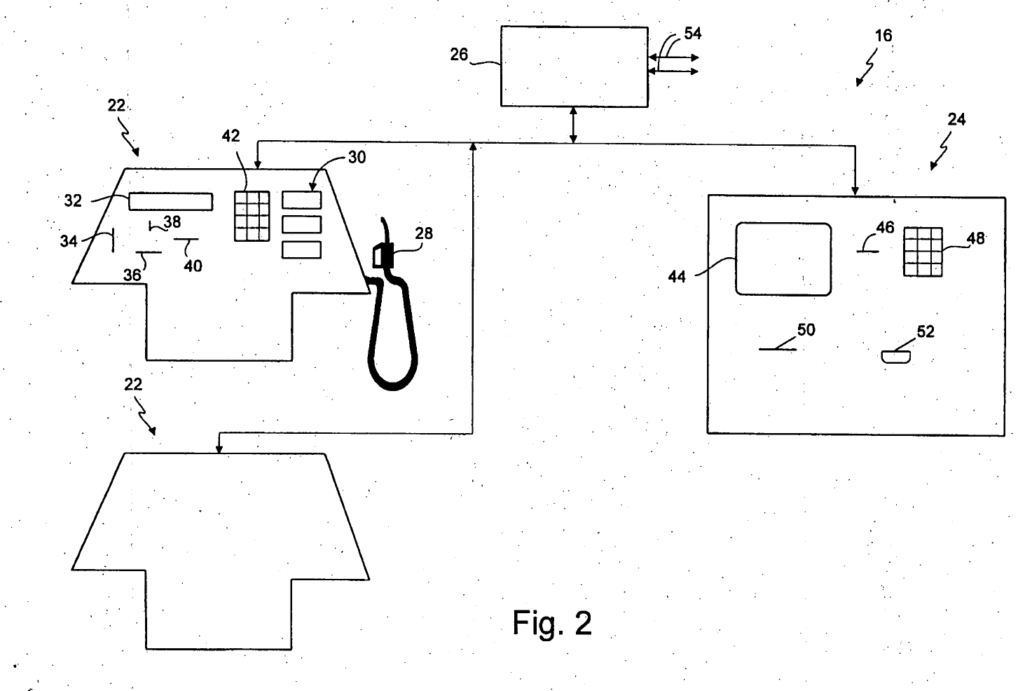

Additional details of a filling station site 16 are shown in FIG. 2. The illustrated pump system 22 can receive payment in a variety of forms including cash, credit or debit cards, and previously issued system credit, i.e., by way of a balance code entered on a keyboard or, optionally, a coded voucher. In this regard, the pump system 22 includes some or all of a card reader 34, such as a conventional magnetic card swiper, a bill acceptor 36, an optional coin acceptor 38, and an optional voucher reader 40. Typically, the pump system 22 will include at least a card swiper and a bill acceptor. The voucher reader 40, if provided, receives and processes vouchers containing machine readable code information. For example, the machine readable code information may be provided in the form of a bar code, magnetic coding or other machine readable format. The pump system 22 also includes a message display 32 such as a monochromatic dot matrix display system or other video system for displaying various messages such as instructions, prompts, advertisements, and error messages. A user input device such as a key pad 42 may be also provided for various user input functions such as (optionally) selecting payment type, entering a security or prior payment balance code, and approving payment amounts. The pump system 22 also includes conventional pump components such as a fuel dispenser nozzle 28 and a pump display 30 for displaying a running transaction amount, price information and fuel amount.

The illustrated change dispenser system 24 receives code information input by a customer, retrieves associated coded balance information from the site controller 26 and dispenses change in the form of bills and coins. The system 24 which may be, for example, a cash machine manufactured by Diebold, Inc. of Canton, Ohio. The cash machine will generally include: a dispenser display 44 for displaying instructions, prompts, advertisements and the like; voucher reader 46, if provided, receives and processes vouchers containing machine readable code information; a user input device such as a key pad 48 for manually inputting code information, identification information or the like; a bill dispenser 50 providing change in the form of bills such as some or all of United States twenty dollar bills, ten dollar bills, five dollar bills and one dollar bills; and a coin dispenser 52 for dispensing change in the form of coins such as some or all of quarters, dimes, nickels and pennies. The cash machine may also include additional features associated with conventional ATM's. For example, the cash machine may cash withdrawal functions, check depositing functions, balance inquiry functions, and the like.

For simplicity, the change dispenser system 24 may use only a smaller set of denominations. For example, dimes may be eliminated as they can be readily replaced by nickels. In one embodiment, when a malfunction occurs in the coin dispenser 52, the maximum amount of change will be dispensed to the customer. For example, if the quarters dispenser malfunctions and the change due would ordinarily entail one or more quarters, the customer may be given the change due less the quarters, together with a code associated with the amount owed due to the undispensed quarters. The code can then be used for fuel or, at a later date or separate machine, to obtain change. This may be accomplished in response to a malfunction signal generated by the quarter dispenser. Alternatively, one of the other coin dispensers, e.g., the nickel dispenser, may be used to dispense the appropriate amount of change to the customer. If a difference still remains between the dispensed amount and the amount owed, the customer will receive new code information that allows the change to be received at a later date.

The pump system 22 and the change dispenser system 24 are interconnected to form a network. The network also includes the site controller 26 that performs a number of functions including monitoring pump system operations, generating and recording codes together with associated balances, receiving code inputs from the cash dispenser system 24, and controlling operation of the cash dispenser system 24 to provide change. The site controller 26 also includes at least one communication port, generally identified by arrows 54, such as for moderns, alarm paging, or inking with change back machines. The communication ports allow the site controller 26 to communicate with external card authorization systems, such as the BUYPASS, PAYPOINT or other credit card authorization network, and the host computer 12 (FIG. 1) of the automated filling station network 10. Multiple parts, e.g., more than two, may be used. The site controller 26 of the illustrated embodiment is a computer and can be any suitable processing system such as, for example, an Intel PENTIUM based IBM compatible system with at least a 1 GB hard drive and 16 MB of RAM. The site controller 26 may run Microsoft Windows 95 or another operating system.

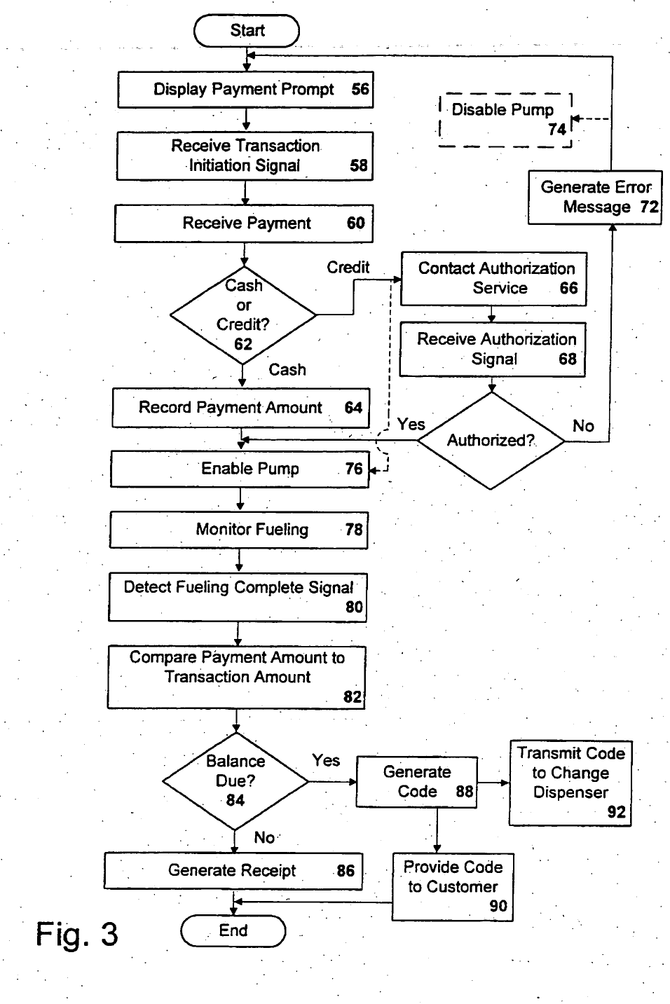

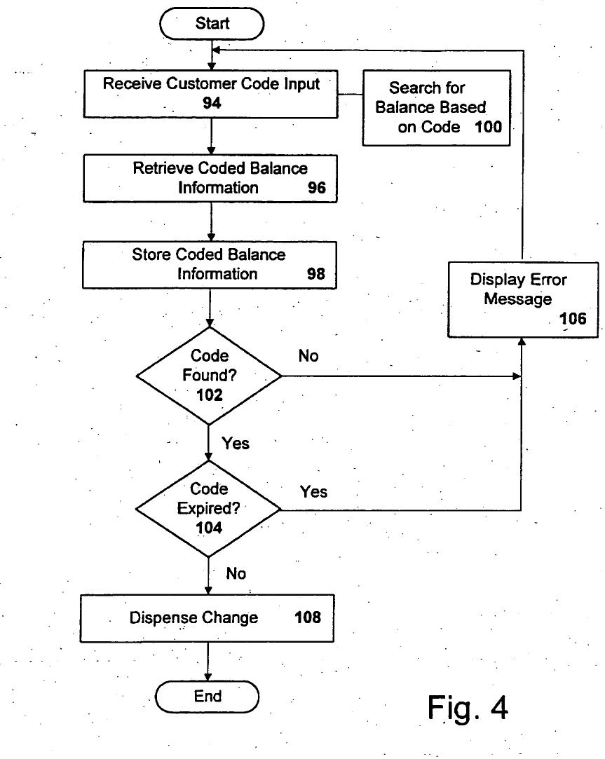

Various functions that are executed by the site controller 26 are outlined in the flow diagrams of FIGS. 3 and 4. More specifically, FIG. 3 illustrates a number of pump system related processes and FIG. 4 illustrates various cash dispenser system related processes.

Referring to FIG. 3, a pump system may be programmed to continuously or periodically display (56) a payment prompt such as “select payment type” or “insert payment” between transactions. A customer initiates a transaction by inserting a card, cash, or (where applicable) a credit voucher. The controller receives (58) a corresponding transaction initiation signal and the pump system receives and credits (60) payment. Payment is typically received at the pump system by receiving currency through the bill acceptor or by obtaining authorization of a credit or debit card in a specified amount (even though only the transaction amount may eventually be debited from the corresponding card account). Further processing of the transaction depends on whether the customer has selected cash or credit (62).

For cash payments, the control system monitors the amount of currency received through the bill acceptor and records (64) the total payment amount. The bill acceptor 36 (see FIG. 2) generally comprises an optical scanner 65 and a bill stacking system 67. A bill fed into the bill acceptor 36 is optically scanned by the optical scanner 65. The optical scanner produces a signal indicated by arrow 69 that identifies the denomination of the bill. The bill is then routed through the bill stacking system. The illustrated acceptor 36 further includes a malfunction signal generator 71. The generator 71 transmits malfunction signals 73 to the control system in the event of a bill jam. When a bill jam is reported (e.g., automatically in response to a malfunction signal or manually by a customer), an operator and/or the control system can then verify the amount owed. More specifically, the record (64) is not completed until the bill has been stacked within the bill stacking system. If a malfunction, i.e., a bill jam occurs, the malfunction generally occurs within the bill stacking system. As a result, the record (64) is not posted to the control system and the customer does not receive credit for the jammed bill. An error message may then be generated by the control system (72) informing the customer of the malfunction. The signal identifying the denomination of the jammed bill can then be used to enable (76) the pump or used to provide a code to the customer. In addition, as described in greater detail below, the error message and the denomination of the jammed bill is generally communicated to a remote computer center. The remote computer center can add code information and associated balance due information to a data base based on the denomination of the jammed bill which allows the customer to input the code into the pump system and enable (76) the pump. In another embodiment, the remote computer center can provide direct customer service by enabling (76) the pump or otherwise assisting the customer.

For credit payments, the control system contacts (66) an authorization service, waits for a response and receives (68) an authorization signal. If the card is not approved, the control system generates (72) an error message which is displayed to the customer. If the card is authorized, or if the customer pays in cash, then the pump is enabled (76) and the fueling process can begin.

Alternatively, the pump may be enabled prior to obtaining authorization as indicated in phantom on FIG. 3. If authorization is subsequently denied, then the control system can disable (74) the pump after fueling has been initiated. It will be appreciated that such immediate pump enablement entails a risk of loss by the fuel vendor. However, it is anticipated that any such losses will be minimal due to the speed of operation of the authorization system. Any such losses may be justified by the improved customer convenience and customer throughput resulting from reduced authorizition delays.

During the fueling process the control system monitors (78) the fueling process to detect (80) a fueling complete signal. Depending upon the type of pump system employed, such a fueling complete signal may be generated in response to hanging up the pump nozzle or in response to manually turning the pump off by flipping a pump lever. Upon detecting the fueling complete signal, the control system communicates with the pump system to determine the transaction amount and compares (82) the payment amount to the transaction amount to determine whether a balance is due (84). If no balance is due, the control system will only generate a receipt (86) if requested by a customer, and the pump system related process is complete. On the other hand, if a balance is due, the control system generates (88) a code and associates the code with the balance due. The code can be generated by any suitable software such as random or modified random number generator (excluding previously used codes), or custom software for selecting predetermined codes from a code database. The control system relates the code to the corresponding balance and stores the code and balance in a coded balance data base that is indexed by code. In this manner, the coded balance information can be transmitted (92) to the change machine in response to a code input by the user.

The code can be provided (90) to the customer in any suitable form. For example, the code can be printed on the transaction receipt that is reported to the customer. Alternatively, a code such as a password or character string can be displayed to the customer on the pump system monitor. As a further alternative, it is anticipated that the pump system may be provided with the capability to issue a ticket or voucher to the customer that includes optically or magnetically encoded information corresponding to a numeric or alphanumeric code.

Once the customer has received the code, the customer may either retain the code and receive credit for the balance due in a subsequent fueling transaction at a site within the automated filling station network, or the customer may proceed with the code to the change dispenser system to receive change in the form of currency. FIG. 4 illustrates the change dispenser system related process. The process can be implemented by the customer in response to instructions and/or prompts displayed on the change dispenser system monitor. Upon approaching the change dispenser system, the customer initiates the change dispenser system process by entering the code supplied by the pump system e.g., by entering the code manually or, where available, by inserting a machine-readable voucher. The code is transmitted to the control system by the change dispenser system. The control system receives (94) the customer code input and retrieves (96) the coded balance information which has been stored (98) by the control system in computer memory. More particularly, the coded balance information is retrieved by searching (100) through the code indexed balance information data base based on the received code. If the code is found (102) and has not expired (104), then the change dispenser system dispenses (108) change in the form of currency in the amount indicated by the coded balance information. In this regard, it will be appreciated that network operators may desire to attach expiration dates to particular codes (e.g., 90 days after traction date) for bookkeeping purposes. If the code is not found, or is expired, an error message is displayed (106) to the customer and the process may be restarted.

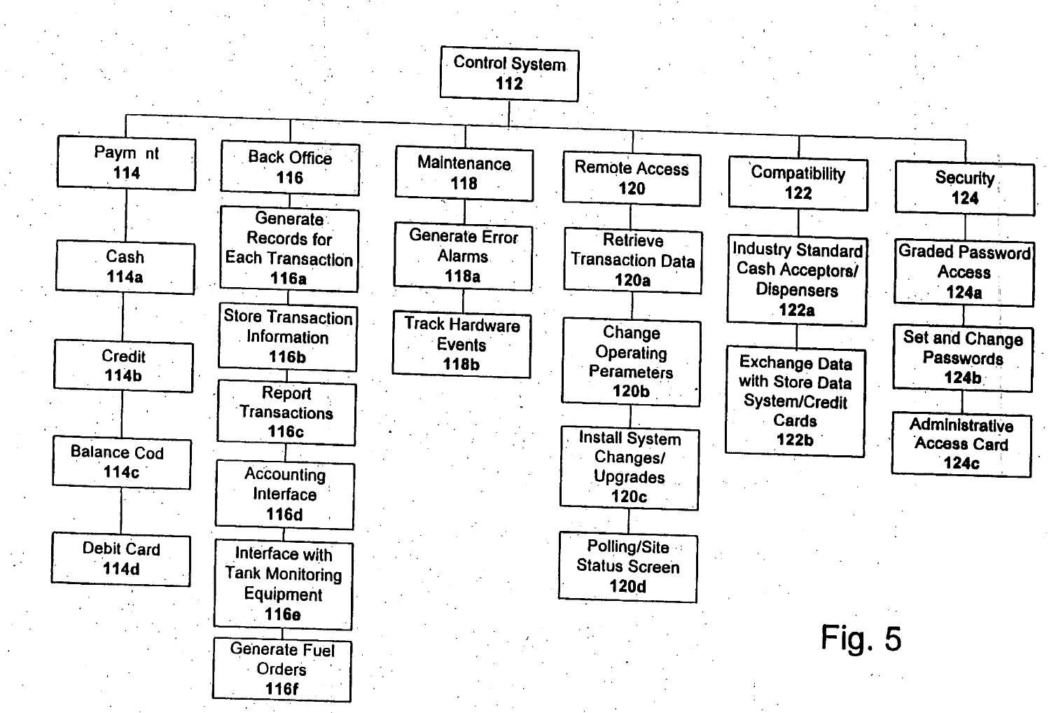

FIG. 5 shows a number of functions and implementation options for the control system of the automated filling station network. These functions can be executed by the remote host computer, the site controller or other elements of the overall control system. The illustrated functions can generally be grouped into the following categories: 1) payment functions (114); 2) back office functions (116); 3) maintenance functions (118); 4) remote access functions (120); 5) compatibility functions (122); and 6) security functions (124). The payment functions (114) include recognizing and crediting customer payments received in the form of cash (114a), a credit card (114b), balance codes (114c) manually entered or encoded into credit vouchers, and a debit card (114d). The back office functions (116) can be varied as desired depending on the filling station environment and operator preferences. In the illustrated embodiment, the back office functions implemented by the control system (112) include generating (116a) records for each transaction, storing (116b) transaction information for backup record keeping in the case of transmission failures between the filling station site and the remote host computer, reporting (116c) the transaction information (e.g., in the form of printouts) to the system administrator and providing (116d) an accounting interface between the control system and accounting programs associated with the remote host computer or a data system of a store associated with the filling station. The back office functions (116) also include providing (116e) an interface with tank monitoring equipment to track fuel inventory and generating (116f) fuel orders when fuel inventory reaches a selected level. The fuel orders can be transmitted to the host computer or directly to a supplier via a pager or computer interface.

The maintenance functions (118) include generating (118a) error alarms and tracking (118b) hardware events such as malfunctions, revisions or tampering. The error alarms may take various forms such as transmitting an error message to the host computer or paging a servicing agent. The nature of the error alarm generated may depend, for example, on the urgency of the identified error, the time of day, etc. Error messages may include some or all of the following: 1) pump off line; 2) pump paper is out; 3) pump paper is low; 4) credit card interface is down; 5) pump not reset for next sale; 6) receipt paper jammed; 7) bill acceptor jammed; and 8) emergency shutoff activated.

The remote access function (120) allows the filling station site to be monitored and controlled via the remote host computer. These functions include retrieving (120a) transaction data, changing (120b) operating parameters such as fuel prices, expiration periods for codes, prioritization of error alarms, installing (120c) system changes and upgrades by downloading codes from the remote host computer to the site controller, and polling (120d) the filling station sites and displaying the site status on a monitor associated with the remote host computer. Preferably, the site status for a given site is formatted to show all status information for a particular site on one screen. The status information can include, for example, the current status and history of all alarm parameters.

The compatibility functions (122) ensure that the control system can communicate with various related data systems. For example, the fuel pump systems preferably employ industry standard cash acceptors and dispensers. Accordingly, the compatibility function (122) assures compliance with such standards (122a). In addition, in the case of a filling station site associated with a store, the control system may be designed for compatibility with the store's data system (122b) to exchange data for inventory and bookkeeping purposes. Similarly, the control system (112) may be programed to accept the same credit cards under the same conditions as the store.

The security functions (124) are intended to discourage improper access to the network. The security functions (124) preferably define a number of security levels or grades (124a) for controlling access to the network. For example, a fuel vendor may be allowed access for the limited purpose of monitoring fuel inventory and reporting refueling levels. A vending machine servicing agent may be allowed access to the network for the limited purpose of monitoring coin and bill supplies and restocking as necessary. The control system also preferably allows passwords to be set and changed (124b) as desired from the remote host computer. Finally, the security system may verify (124c) administrative access cards which allow access to network administers for retrieving records, upgrading systems and performing other administrative functions.

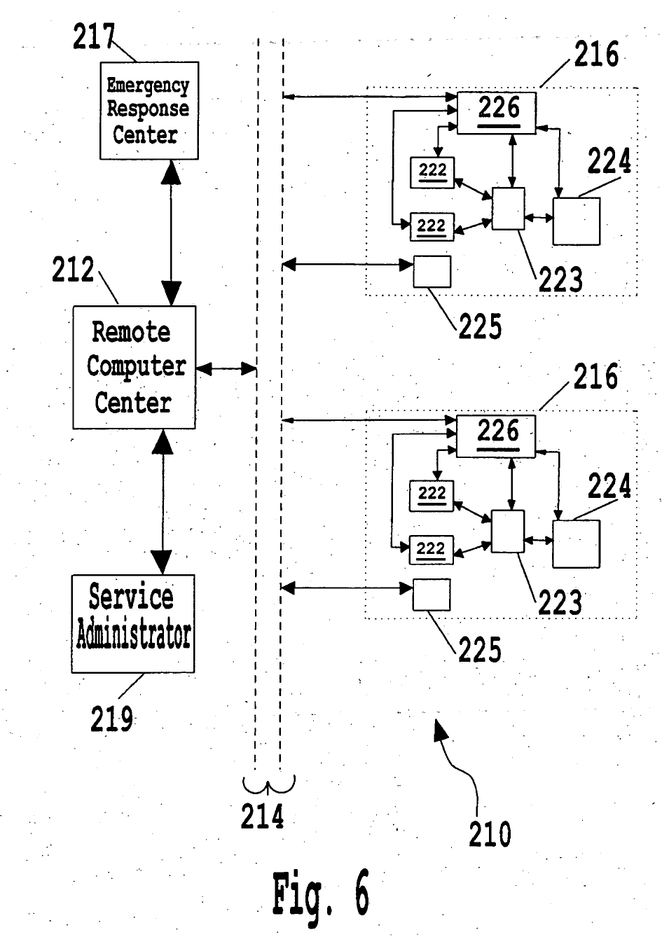

Referring to FIG. 6, another embodiment of an automated filling station network 210 is shown illustrating various functions and components of the present invention. Generally, the network 210 includes a number of filling station sites 216 that communicate with a remote computer center 212 via a public or private communications network 214. The network 210 further includes an emergency response center 217 and a service administrator 219, each in communication with the remote computer center 212. It will be appreciated that any number of these components may be included in the network 210. For example, a large number of filling station sites 216 may be controlled by a single remote computer center 212 while it may be appropriate to have a separate service administrator 219 and emergency response center 217 for each particular geographic area Each filling station site 216 includes a number of fuel pump systems 222, an alarm system 223, at least one change dispenser system 224, at least one customer communication system 225, and a site controller 226. As described above, the site controller 226 implements logic embodied in software, firmware, and/or hardware for controlling operation of the filling station site 216.

Referring to FIG. 6, the network 210 includes a number of communication links to facilitate interaction of the various components of the network 210. During operation, a customer initiates a transaction by inserting a payment amount in the form of a card, cash, or a credit voucher at pump system 222. Pump system 222 communicates with site controller 226 which authorizes fueling, calculates a balance code at the end of fueling, and transmits the code to pump system 222 for display and/or dispensing to the customer. The customer may then enter the balance code at the change dispenser 224 which communicates with the site controller 226 and which then dispenses change to the customer based on this communication. Information or data regarding the amount of fuel pumped, the currency received at each pump system 222, and the currency dispensed by the change dispenser 224 may be stored by the site controller 226. Periodically, this information may be transmitted or downloaded to the remote computer center 212 for further processing. In this manner, the remote computer center 212 may include logic for processing this information to determine servicing schedules for each filling station sites 216 and then communicating these service schedules to the service administrator 219, thereby facilitating timely and cost effective maintenance of the filling station sites 216 within network 210. The remote computer center 212 may also process this information to determine daily or periodic sales information (e.g., profit) for accounting and administrative purposes.

As may be appreciated, fuel prices may fluctuate periodically and may vary based upon geographic location because of competitive forces, changes in supply and demand, and other market related reasons. It may be desirable to set or establish the fuel price at each filling from the remote computer center 212 to save the cost of periodically, often daily, servicing each filling station site 216 merely to change fuel prices. In this regard, the remote computer center 212 may be operated to monitor and establish fuel prices within network 210. The remote computer center 212 may transmit a new fuel price to site controller 226 at a filling station site 216. The site controller 226 employs this new fuel price when determining transaction amounts associated with future fueling transactions. The site controller 226 also operates the pump system 222 to display the new fuel price to customers. The site controller 226 or remote computer center 212 may similarly operate any associated display systems (e.g., automated bill boards on site or offsite, such as along a highway) visible to customers at the filling station site 216 or at separate locations.

If a customer experiences difficulties in operating the pump system 222 or in obtaining change at change dispenser 224, the customer may operate customer communication system 225 to communicate with the remote computer center 212 via communications network 214. For example, customer communication system 225 may comprise a telephone located near change dispenser 224. When a change dispenser malfunctions, the customer may use the telephone of the customer communication system 225 to call (e.g., free of charge with a 1-800 number) the remote computer center 212. The remote computer center 212 may respond by transmitting a new balance or refund code to the customer for immediate or later use. As can be appreciated, the appropriateness of a refund may be verified by cross-checking the customer's original balance code (e.g., has it been previously dispensed) and/or the customer's fuel authorization code. With a refund code in hand, the customer may operate the change dispenser to obtain currency. If a continuing malfunction is experienced, the remote computer center 212 can relay this information to the service administrator 219 for correction of the problem.

The filling station site 216 further includes an alarm system 223 interconnected with the pump systems 222, the change dispenser 224, and the site controller 226. The alarm system 223 may be designed to provide continuous monitoring of the physical integrity of the pump systems 222 and the change dispenser 224 and to transmit current status and alarm signals to the site controller 226 for further processing. For example, if physical damage occurs at a change dispenser 224, the alarm system 223 transmits an alarm signal to site controller 226. Site controller 226 processes and transmits this information via communication network 214 to remote computer center 212. Remote computer center 212 receives this information, determines an appropriate alarm response, and transmits this alarm response to the emergency response center 217. In this manner, the automated, and often remotely located, filling station sites 216 can be efficiently and cost effectively monitored and maintained against physical damage that would detrimentally affect continuing operation.

As may be appreciated, the change dispenser 224 may have an integral or substantially integral alarm system 223. For example, the change dispenser 224 may be an ATM-type machine, such as that manufactured by Diebold, Inc., having an integral security system (e.g., alarm systems) that includes integral camera surveillance, electronic access locks, alarm sensors, and seismic vibration detectors. Referring to FIG. 6, the alarm system 223 of the present invention may be integral to change dispenser 224 with the alarm system 223 including a sensor(s) for monitoring the physical integrity of the change dispenser 224 and communication ports for linking the alarm system 223 to a communications network 214 via site controller 226. The alarm system 223 may further include a sensor(s) placed on the pump systems 222 interconnected to the integral portion of the alarm system 223 at the change dispenser 224. In this regard, the sensor(s) of the pump systems 222 monitors physical integrity of the pump systems 222 and, specifically, of the cash receipt portions. In this manner, the alarm system 223 may be employed to transmit current status and alarm signals regarding the filling station site 216 to the remote computer center 212, which may forward alarm signals to the emergency response center 217, as appropriate. Additionally, the alarm system 223 may be directly linked (e.g., bypassing the site controller 226) to an emergency response center 217, such as a police station or a private security service, to facilitate prompt response to any emergency signals transmitted by the alarm system 223.

The automated filling station network of the present invention provides on the spot change in the form of currency or credit voucher for use and subsequent fueling transactions as desired by the user. In addition, the automated filling station network of the present invention allows the remote computer center 212 to perform diagnostic evaluation of malfunctions. The invention also enables various malfunctions such as bill jams to be immediately verified and addressed while the customer is on site and without requiring the intervention of an attendant. Furthermore, the remote computer center 212 may control other operational parameters associated with automated filling station network without being located near the automated filling station. The network also enhances customer convenience, reduces labor costs and hazards to personnel and reduces operating costs and fuel prices. The network thereby realizes many of the potential advantages of automated filling stations that have not been achieved in conventional systems.

While various implementations of the present invention have been described in detail, it is apparent that further modifications and adaptations of the invention will occur to those skilled in the art. However, it is to be expressly understood that such modifications and adaptations are within the spirit and scope of the present invention.

What is claimed is:

1. A method for use in operating a filling station, comprising:
providing a fuel pump system for receiving payments and pumping fuel in response to said payments;
providing a change dispenser for dispensing change in currency;
receiving a payment from a customer in a customer selected amount;
operating a controller to:
monitor a fueling process by said customer to determine a transaction amount;
compare said transaction amount to said user selected payment amount to determine a balance; and
communicate said balance to said change dispenser; and
using said change dispenser to dispense change to said customer based on said communicated balance; and
communicating operating information to a remote computer center at a location separate from said filling station via a communications network said operating information being useful for monitoring the operation of said filling station by a filling station operator.
